(19) United States
(12) Patent Application Publication
(10) Pub. No.: US 2022/0108442 A1
(43) Pub. Date: Apr. 7, 2022

(54) Identifying Morphologic, Histopathologic, and Pathologic Features with a Neural Network

(71) Applicants: Leif E. Honda, Rye, NH (US); Jon C. Wetzel, Germantown, TN (US); Phil A. Cestaro, Memphis, TN (US)

(72) Inventors: Leif E. Honda, Rye, NH (US); Jon C. Wetzel, Germantown, TN (US); Phil A. Cestaro, Memphis, TN (US)

(21) Appl. No.: 17/449,727

(22) Filed: Oct. 1, 2021

Related U.S. Application Data
(60) Provisional application No. 63/086,626, filed on Oct. 2, 2020.

(51) Int. Cl. G06T 7/00; G06T 3/40

(52) U.S. Cl. CPC G06T 7/0012; G06T 3/40; G06T 2207/30024; G06T 2207/20084; G06T 2207/10056; G06T 2207/20081; G06T 2207/30096

(57) ABSTRACT

A system and method for use in a standardized laboratory for a specimen including a staining specific for a marker in the specimen. The method includes scanning an image, having an image magnification, of the specimen; and detecting morphologic, histopathologic and pathologic (MHP) features in the image, where the app includes a neural network (NN) trained by (a) importing into the NN, control images and associated annotations, where each of the associated annotations identifies one of the MHP features, (b) analyzing a test image with the NN to generate testing annotations for portions of the test image, (c) assessing whether the testing annotations are satisfactory, (d) enhancing the NN when the testing annotations made by the NN are unsatisfactory by repeating the importing, the analyzing and the assessing, and (e) creating the app including the NN when the testing annotations made by the NN are satisfactory.

### CROSS-REFERENCE TO RELATED APPLICATIONS AND INCORPORATION BY REFERENCE

The present application claims the benefit under 35 U.S.C. 119(e) of U.S. Provisional Application Ser. No. 63/086,626, filed Oct. 2, 2020, which is incorporated herein by reference in its entirety.

### FIELD

A system and method to identify Morphologic, Histopathologic and Pathologic (MHP) features with accuracy using a Neural Network (NN) for lower costs is disclosed. A speedup of existing manual processing is achieved by scanning an image and using an advanced neural network. An automated process presents significant reduction in time and costs necessary to evaluate the specimens, while offering both quantitative and qualitative data beyond the present capabilities.

### BACKGROUND

Identifying morphologic, histopathologic and pathologic features is very cumbersome and expensive. Manual preparation, multiple material transfers, and human visual microscopic observation create long production times and delays in the extraction and analysis of pathological, immunohistochemical, and genomic information. This leads to delays in diagnosis, decision and treatment.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

A system and method to identify Morphologic, Histopathologic and Pathologic (MHP) features with accuracy for lower costs is disclosed. The system and method use a neural network to identify, quantify and locate MHP features.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for use in a standardized laboratory using a digital image analysis system including a computer processor. The method includes scanning an image, having an image magnification, of the specimen; and detecting, with a computer executing an app, morphologic, histopathologic and pathologic (MHP) features in the image, where the app includes a neural network (NN) trained by (a) importing into the NN, control images and associated annotations, where each of the associated annotations identifies one of the MHP features, (b) analyzing a test image with the NN to generate testing annotations for portions of the test image, (c) assessing whether the testing annotations are satisfactory, (d) enhancing the NN when the testing annotations made by the NN are unsatisfactory by repeating the importing, the analyzing and the assessing, and (e) creating the app including the NN when the testing annotations made by the NN are satisfactory, where the image is neither one of the control images nor the test image, each of the control images is different from the test image, and the control images and the test image includes images of the MHP features, and where the detecting includes using magnifications less than or equal to the image magnification to detect one or more of the MHP features. Other embodiments of this aspect include corresponding computer systems, apparatus, and computer programs recorded on one or more computer storage devices, each configured to perform the actions of the methods.

Implementations may include one or more of the following features. The method where the specimen includes carcinogenic tissue, and the MHP features include tumor, background and necrotic. The method where the carcinogenic tissue is selected from one or more a lung tissue, an ovary tissue, a colon tissue, a breast tissue, and a skin tissue. The method may include visualizing the MHP features using a different color for each of the MHP features. The method may include generating a heatmap illustrating concentrations of the MHP features using different colors for each of the MHP features and different intensities of the different colors for respective concentrations of the MHP features. The method may include generating a heatmap including outlining and corings illustrating concentrations of one of the MHP features in a portion of the image. The method where the image magnification is equal to or greater than 20×, and the magnifications includes one or more of 0.5×, 1×, 5×, 10×, 20× and 40×. The method may include scaling the image to one of the magnifications. The method where the variables include one or more of a total tissue area, a percentage of the total tissue area having one of the MHP features, a score indicating a presence of one of the MHP features in the image, a count of nuclei for one of the MHP features, and measurements of a hot zone of one of the MHP features. The method may include identifying a hot spot of the MHP features in a portion of the image. The specimen may be stained using one or more of Hematoxylin and Eosin (H&E), Immunohistochemistry (IHC), Fluorescence In-situ Hybridization (FISH), Chromogenic In-situ Hybridization (CISH), Spectral Imaging, Confocal Microscopy and other simulated staining techniques. Implementations of the described techniques may include hardware, a method or process, or computer software on a computer-accessible medium.

One general aspect includes an automated method for use in a standardized laboratory using a digital image analysis system including a computer processor. The automated method includes scanning an image, having an image magnification, of the specimen; detecting, with a computer executing an app, morphologic, histopathologic and pathologic (MHP) features in the image; quantifying variables for one or more of the MHP features in a portion of the image; and visualizing the MHP features using different colors for each of the MHP features, where the app includes a neural network (NN) trained by (a) importing into the NN, control images and associated annotations, where each of the associated annotations identifies one of the MHP features, (b) analyzing a test image with the NN to generate testing annotations for portions of the test image, (c) assessing whether the testing annotations are satisfactory, (d) enhancing the NN when the testing annotations made by the NN are unsatisfactory by repeating the importing, the analyzing and the assessing, and (e) creating the app including the NN when the testing annotations made by the NN are satisfactory. In the method, the image is neither one of the control images nor the test image, each of the control images is different from the test image, and the control images and the test image include images of the MHP features. In the method, the detecting includes using magnifications less than or equal to the image magnification to detect one or more of the MHP features. In the method, the image magnification is equal to or greater than 20×, and the magnifications include one or more of 0.5×, 1×, 5×, 10×, 20× and 40×. In the method, the specimen is selected from one or more a lung tissue, an ovary tissue, a colon tissue, a breast tissue, and a skin tissue. In the method, the MHP features may include tumor, background and necrotic. In the method, the specimen includes a hematoxylin and eosin (H&E) staining. Other embodiments of this aspect include corresponding computer systems, apparatus, and computer programs recorded on one or more computer storage devices, each configured to perform the actions of the methods.

Implementations may include one or more of the following features. The method may include generating a heatmap illustrating concentrations of the MHP features using different intensities of the different colors for respective concentrations of the MHP features. The method may include generating a heatmap may include corings illustrating concentrations of one of the MHP features in a portion of the image. The method may include annotating each of the MHP features in a portion of the image. The method may include scaling the image to one of the magnifications. The method where the variables include one or more of a total tissue area, a percentage of the total tissue area having one of the MHP features, a score indicating a presence of one of the MHP features in the image, a count of nuclei for one of the MHP features, and measurements of a hot zone of one of the MHP features. The method may include identifying a hot spot of the MHP features in a portion of the image. Implementations of the described techniques may include hardware, a method or process, or computer software on a computer-accessible medium.

One general aspect includes a method for training a neural network (NN) to detect Morphologic, Histopathologic and Pathologic (MHP) features from an image of a specimen. The method includes importing into the NN, control images and associated annotations, where each of the associated annotations identifies one of the MHP features; analyzing a test image with the NN to generate testing annotations for portions of the test image; assessing whether the testing annotations are satisfactory; enhancing the NN when the testing annotations made by the NN are unsatisfactory by repeating the importing, the analyzing and the assessing; and creating an app including the NN when the testing annotations made by the NN are satisfactory. In the method, the image is neither one of the control images nor the test image, each of the control images is different from the test image, and one or more of the control images and the test image include images of the MHP features. Other embodiments of this aspect include corresponding computer systems, apparatus, and computer programs recorded on one or more computer storage devices, each configured to perform the actions of the methods.

Implementations may include one or more of the following features. The method may include annotating the control images with the respective annotations. Implementations of the described techniques may include hardware, a method or process, or computer software on a computer-accessible medium.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1A illustrates an exemplary process to train a NN to identify MHP features of a specimen according to various embodiments.

FIG. 1B illustrates an exemplary process for an App used in a standardized laboratory according to various embodiments.

FIG. 2 illustrates an exemplary system to identify MHP features of a specimen according to various embodiments.

FIG. 3 illustrates an exemplary tissue detection from an image according to various embodiments.

FIG. 4 illustrates an exemplary MHP Detection from an image including Tumor (Blue), Background (Green), Necrosis Detection (Red) areas according to various embodiments.

FIG. 5 illustrates an exemplary Tumor Post Processing of an image to generate data points according to various embodiments.

FIG. 6 illustrates an exemplary nuclei detection from an image according to various embodiments.

FIG. 7 illustrates an exemplary nuclei detection including tagging of nuclei in an image according to various embodiments.

FIG. 8A illustrates an exemplary heat map of nuclei according to various embodiments.

FIG. 8B illustrates an exemplary heat map with coring of nuclei according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer (hosted or virtual), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

The present teachings disclose a system and method to identify Morphologic, Histopathologic and Pathologic (MHP) features with accuracy for lower costs is disclosed. The system and method use a neural network to identify, quantify and locate MHP features. Detection and quantifying of tumors and nuclei in the present teachings is exemplary. The present teachings may be used to detect and quantify cells including lymphocytes in specimens. The present teachings may be used to identify neurological samples and quantifying neurons in specimens. The present teachings may be used to detect and quantify non-diseased tissues include normal or healthy tissues and cells, adipose cells, rare cell types, stem cells, or progenitor cells in specimens.

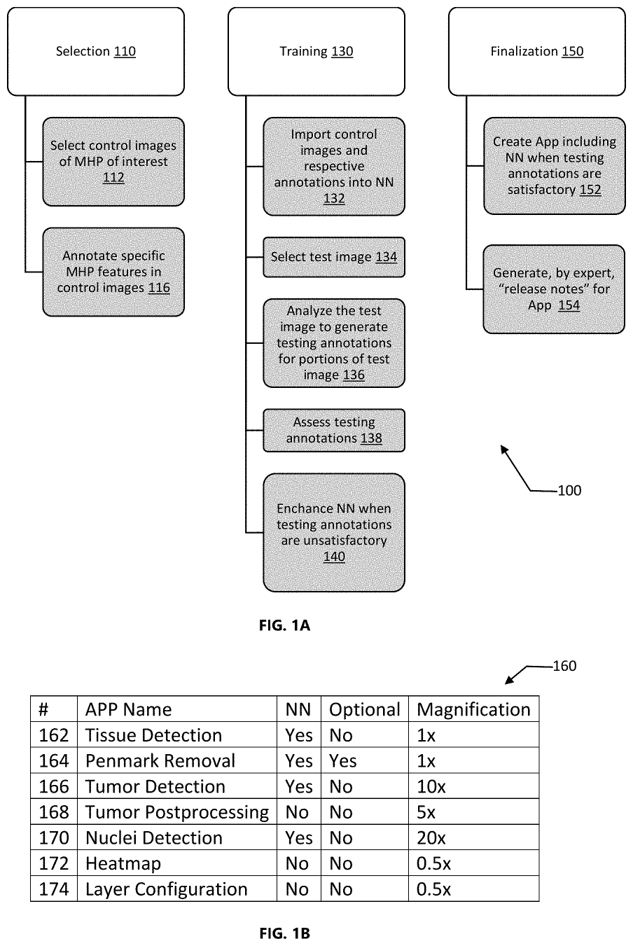

FIG. 1A illustrates an exemplary process to train a NN to identify MHP features of a specimen according to various embodiments.

A method 100 for using a Neural Network (NN) for identifying a MHP may be viewed as a selection branch 110, a training branch 130 and a finalized branch 140. Some or all of the operations of the selection branch 110 may be performed by an expert, such as a pathologist. The selection branch 110 may include operation 112 to select control images. The control images may be of tissue, stained and magnified by a scanner, for MHP of interest. An initial pass through the selection branch 110 with a NN may use control images including most or all of the MHP features. Subsequent passes through the selection branch 110 may use new control images emphasizing undetected or misidentified MHP features by the NN's learning in the previous passes. In one example, the MHP may be a cancer of interest. The selection branch 110 may include operation 116 to annotate specific MHP features in the control images. Annotations may be performed by the expert. Annotations at operation 116 may mark portions of the control images. Exemplary annotations include Tumor Cells, Background (any tissue that is not Tumor or Necrosis), or Necrotic areas. Annotations other than tumor, background or necrotic may be used.

The training branch 130 may include operation 132 to import the control images and their respective annotations into the NN. Operation 132 may be performed by someone other than the expert. The importing of control images in operation 132 trains or causes the NN to learn how to detect MHP features and their associated annotations. The training branch 130 may include an operation 134 to select one or more test images. The test images and control images should not overlap, and maybe from different specimens. The test images and control images of each pass of the selection branch 110 and the training branch 130 may not overlap. The training branch 130 may include operation 136 to analyze the test image to generate testing annotations for portions of test image.

The training branch 130 may include operation 138 to assess adequacy or satisfaction of the testing annotations generated by the NN in operation 136. The assessment of operation 138 may be performed by the expert. A satisfactory NN need not adequately detect/identify the MHP features in all permutations. A satisfactory NN may adequately detect/identify the MHP features in a majority or most common permutations. The training branch 130 may include operation 140 to enhance the NN when testing annotations were inadequate or unsatisfactory. The enhancing of operation 140 may include one or more of annotating per operation 116, importing per operation 132, selecting per operation 134 and generating per operation 136.

The NN is sent to the finalization branch 150. The finalization branch 150 may include operation 152 to create an App to detect MHP features with the NN that generated the satisfactory testing annotations. The App may include the satisfactory NN and associated learning data for use in a standardized laboratory. In the standardized laboratory, further NN training may be enabled or disabled in the NN. The finalization branch 150 may include operation 154 to generate, by the expert, “release notes” for App. The release notes may include a listing of features that are inadequately identified by the App. The release notes may include minimum requirements for images to be analyzed by the App, method of operation of the App, MHP of interest that the App is usable for, and the like.

FIG. 1B illustrates an exemplary process for an App used in a standardized laboratory according to various embodiments.

An App, generated after the training of a NN per FIG. 1A, may be used in a standardized laboratory without further training. A process 160 may be used by the App to detect and quantify the MHP of interest in the standardized laboratory. The process 160 may be an analysis sequence, as implied by FIG. 1B, on an image of a specimen. The process 160 may produce quantification data and a layer-set for visual inspection. Operations of the process 160 may be generated by specialized sub-programs of the NN. Magnifications of slide images listed below are exemplary; the system may be used at any magnification. The accuracy may decrease with lower magnifications. 20× and 40× are the most common scanned slide images. Accurate nuclei detection may be viable at a minimum resolution of 20×. Accurate tumor detection may be viable at a minimum resolution of 10×.

The process 160 may include operation 162 for tissue detection. Operation 162 may result in generating a boundary 302 of a tissue 300 in the image as seen, for example, in FIG. 3. Operation 162 may be performed on the image having a 1× magnification. The tissue is identified, and further analysis is limited to only the part of the image that contains tissue.

The process 160 may include operation 164 for penmark removal from the image. Operation 164 may be performed on the image having a 1× magnification. The regions from the previous APP are analyzed and penmarks are removed from further analysis.

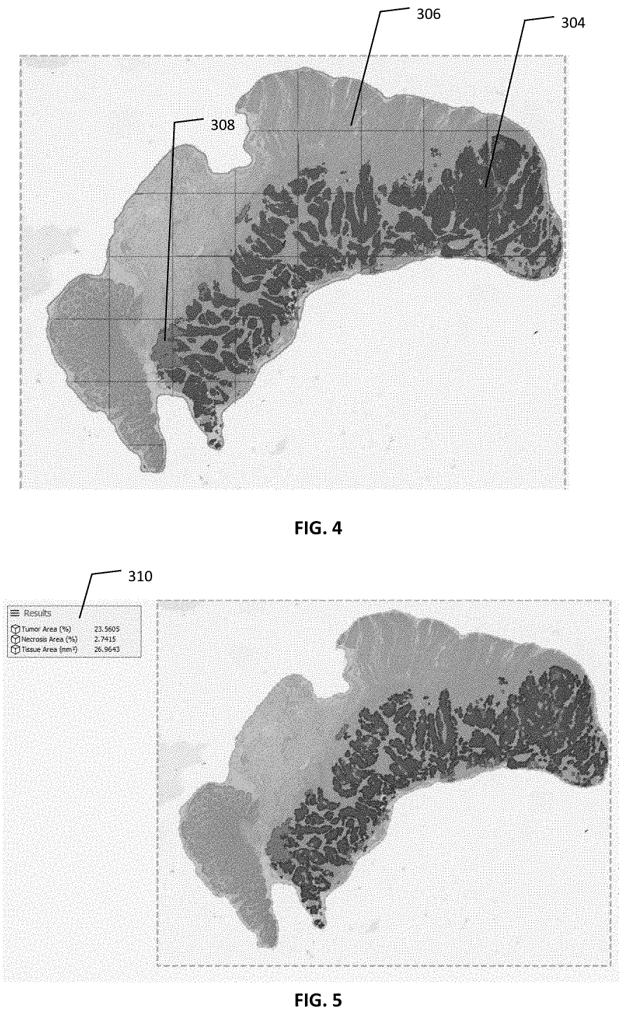

The process 160 may include operation 166 to detect MHP features, for example, tumors. Operation 166 may be performed on the image having a 10× magnification. FIG. 4 illustrates identification of tumors 304 (blue), background (green) 306 and necrosis 308 (red). The tissue is compartmentalized into regions of Tumor, Necrosis and Background. The Background class includes any tissue that is not Tumor or Necrosis.

Process 160 may include operation 168 to post-process the detection of MHP features by operation 166. The Tumor, Necrosis and Background regions may be simplified to speed up further analysis and clean up small not significant regions. Operation 168 may be performed on the image having a 5× magnification. Operation 168 may generate data points 310 as illustrated in FIG. 5. The data points may include a tissue area, a tumor area percentage in the tissue, a necrotic area percentage in the tissue and the like.

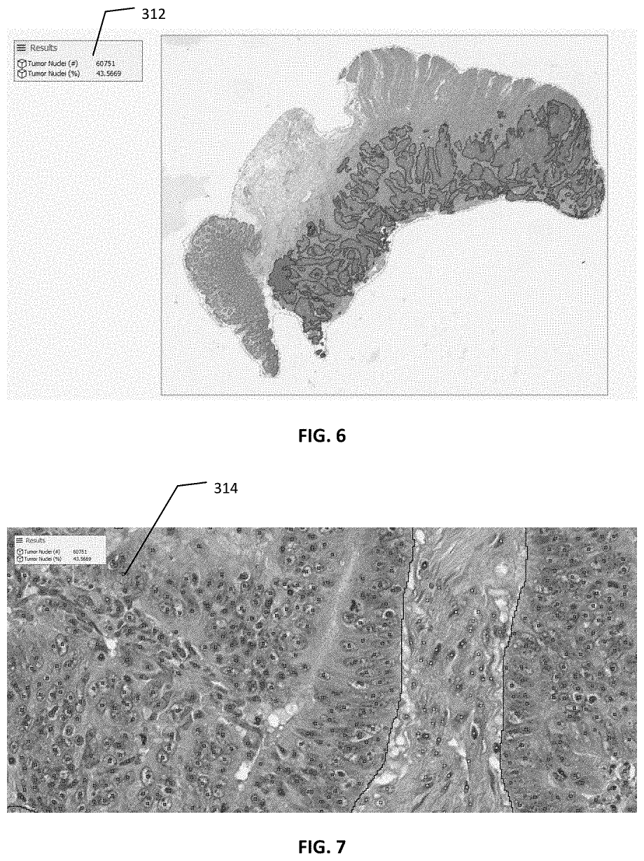

The process 160 may include operation 170 to detect nuclei in the image. generate color map of MHP features. Operation 170 may be performed on the image having a 20× magnification. Operation 170 may generate data points 312 as illustrated in FIG. 6. The data points may include counts and percentages for tumor nuclei, necrotic nuclei and the like. Results produced by the process may be viewed at different magnifications. For example, results of operation 170 may be viewed at a greater magnification, for example, 40×, to show tagging 314 (hot pink) of the detected nuclei.

Nuclei are detected in the Tumor and Background regions. The nuclei will count as Tumor Nuclei or Stroma Nuclei depending on which region, they have the largest overlap with. Stroma Nuclei is used as a catch-all for any nuclei detected in the Background region. When additional features are in use, for example, the Lymphocyte Detection feature, some nuclei within the Tumor region might be flipped to Stroma Nuclei based on their size and intensity. All nuclei are counted and output variables (data points) based on the nuclei counts are calculated.

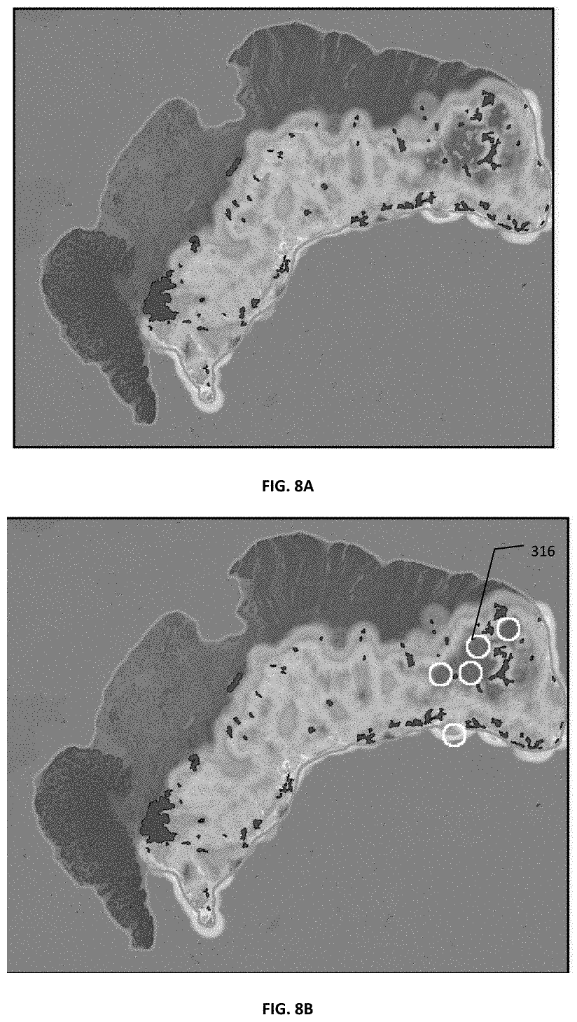

The process 160 may include operation 172 to generate a heatmap of the nuclei in the image. Operation 172 may be performed on the image having a 0.5× magnification. FIG. 8A illustrates such a heatmap. In some embodiments, the heatmap may include coring 316 as illustrated in FIG. 8B. The detected nuclei are used to create a Heatmap that lets you see immediately where the percentage of tumor nuclei are the highest.

The process 160 may include operation 174 to configure and generate layers in the image. Operation 174 may be performed on the image having a 0.5× magnification. This configures the colors of the of the visual output and makes the ROI layer opaque. Operation 174 ensures a consistent visual output and makes changing the colors easy at the end of the analysis sequence. The layers generated may include an ROI layer, a label layer and a heatmap. For example, the ROI layer may use the color blue to illustrate tumors, red for necrosis and green for background. An exemplary label layer may use the color pink to illustrate tumor nuclei and the color teal to illustrate host nuclei.

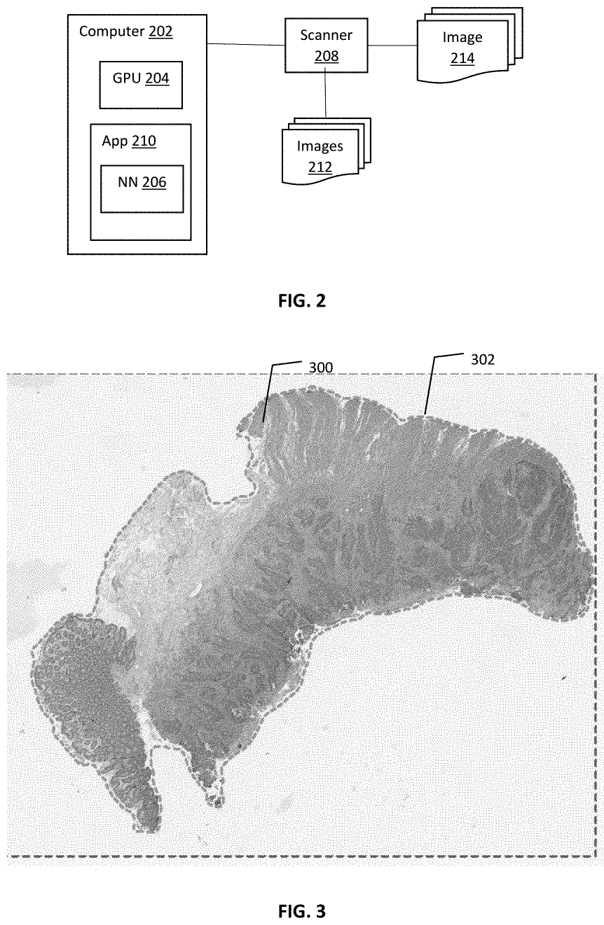

FIG. 2 illustrates an exemplary system to identify MHP features of a specimen according to various embodiments.

A digital analysis system 200 may include a computer 202 including a Graphical Processing Unit (GPU) 204 capable of running a Neural Network (NN) 206 may be used. The system may include a slide scanner 208 for use by the standardized laboratory to scan images 212 of slides of interest. The slide scanner 208 may magnify an image of the slide, for example, 20×, 40× or the like. An expert, for example, a pathologist, may annotate a set of control images. The annotated images are used to train the NN software that creates a trained NN. The trained NN is capable of identifying the MHP of interest. After the trained NN has been tested and verified for correct operation against test images (test images are different than the control images), an app 210 including the trained NN may be generated. After verification, the app 210 may be used with a standardized laboratory image 214. The standardized laboratory image 214 may be the same or different from the test or control images. The standardized laboratory image 214 may be scaled by the App as necessary for a step of the analysis sequence. The scaling may reduce the resolution of the standardized laboratory image 214. In some embodiments, when the standardized laboratory image 214 is of a low-resolution, the scaling may not reduce the resolution.

The App may be used on a general-purpose computer. A Graphics Processing Unit (GPU) may be used enhance the App's performance. An exemplary GPU is an NVIDIA GeForce RTX 2080 Ti. The NN software may be capable of running in real time. The NN software may include a Convolutional Neural Network (CNN) to extract the MHP features and an Artificial Neural Network (ANN) to classify the MHP features. An exemplary NN software is VisioPharm release: 2020.08 Alpha. The digital slide images may be generated from a multitude of Digital Slide scanners. An exemplary slide scanner is the Aperio GT 450. Exemplary slides may be stained using Hematoxylin and Eosin (H&E), Immunohistochemistry (IHC), Fluorescence In-situ Hybridization (FISH), Chromogenic In-situ Hybridization (CISH), Spectral Imaging, Confocal Microscopy and other simulated staining techniques.

Digital slides for training and standardized laboratory use may be created as 10×, 20×, 30×, 50× or the like versions from a digital slide scanner scanning stained slides of a specimen. Subject slides for scanning may be imaged using 2×, 5×, 10×, 20×, 30×, 50× or the like magnifications with the digital slide scanner. In some embodiments, images should be at least 20× magnification for the purposes of training or detecting with the system.

### Exemplary Embodiment

An import of the images to the App may be performed with “New Images to Database (Import)” functionality. Once the images are imported they can be analyzed in batch. Once the batch process has been started the APP Sequence runs on each image in the App Queue. Once an image has been analyzed, the Output Variables and Visual Output may be added to the image in the study folder. For visual clarity, a Heatmap layer at a low-medium opacity may be generated. A Region of Interest (ROI) and Label layer can be used for closer examination and QC of tumor regions (ROI) and nuclei detection (Label). Output Variables for multiple images at a time can be viewed by switching from thumbnail to details view.

Features of the App may include output variables, score (Pass/Fail), Penmark removal, tissue detect size threshold (for example, issue less than <100.000 μm₂ may be excluded), additional lymphocyte detection (for example, thresholds for nuclei size and intensity), heatmap (for example, min-max of feature range), nuclei outline (for example, center dot or outline), visual results (for example, colors, transparency, etc) or the like. Features can be turned on/off or be adjusted for tuning purposes.

A pass-fail score may be provided in some embodiments. For example, a slide level score can be included as an Output Variable, with a “1” being a pass and a “0” being a fail. The resulting score may depend on other output variables and associated thresholds, for example, Tumor Nuclei % and Tumor Nuclei #.

### Workflow Example

Using a divide and conquer approach, a Tumor Detection APP has been trained for five different organ types: Breast, Lung, Colon, Skin Melanoma and Ovary. During the iterative training process, the APP has been continually evaluated and its strengths and weaknesses noted. These are based on validation set of randomly selected WSIs.

An exemplary embodiment of the present teachings started with selection branch (110). Digital Slide images of stained slides including the MHP of interest were selected for the cancer of interest, for example, Lung Adenocarcinoma (112). Images were then imported into the VisioPharm software for annotation (132). A pathologist then reviewed the images and annotated specific morphologic features (116), i.e., Tumor Cells, Background (Normal or inflammatory areas that are not Tumor or Necrotic) or Necrotic areas.

The training of a neural network then began (130). The VisioPharm software was then tasked to analyze the annotations to create an algorithm that could be used to detect these features with a NN (132). A set of Test slides for the same cancer of interest were also selected that the App has never seen and were not used for training (134). The NN was then run on this set of slides (136). A pathologist then reviewed the annotations created by the application to see what morphologic features it had correctly assessed and what it incorrectly assessed (138).

When the pathologist was unsatisfied with the performance of the NN (140), the process switched back to the selection branch 110. For areas that were incorrectly assessed new slides were selected with these morphologic features. A pathologist annotated the new slides (116) so this new information can be added to the training data set for the NN by importing (132). Then the NN was enhanced by repeating operations 132, 134, 136 and 138 above were repeated until the satisfaction of the pathologist at 140.

When the pathologist was satisfied with the performance of the NN (142), the process switched to the finalization branch (150). An App including the version of the NN that the pathologist was satisfied with was then created (152). The pathologist then generated a set of “release notes” about this version of the App identifying any remaining issues (154). These release notes may include areas of improvement on future versions of the app.

### Preliminary Results of Lung Test Cases

The tumor segmentation was very good. In areas of adenocarcinoma, the app identifies well over 98% of tumor cells, and the false positive rate is far less than 1%. Lung adenocarcinomas have a variety of architectural patterns, and the app does a good job with all of them, with the possible exception of the very well differentiated pattern; all the other problematic architectural patterns are focal and so overall app performance is still extremely good with them.

As before, in areas where the tumor is somewhere between viable and necrotic, the app calls the area background. This may be a good way to deal with these areas, as it prioritizes specificity for viable tumor.

Similarly, in mucinous tumors, where the epithelium is somewhere between normal and malignant, the app calls the area background. This may be a good way to deal with this issue, as it prioritizes specificity for definitive tumor.

The app does a very good job of segmenting inflammation as background; this was a problem with some of the other tumor types, but not lung. In fact, in one case, the app accurately found microscopic metastatic tumor in a specimen that was a lymph node. The app correctly segments some areas of solid growth which are probably squamous cell carcinoma rather than adenocarcinoma. Rate tumor patterns where the APP might only get 90% sensitivity and specificity include Micropapillary pattern and Spindle pattern. Difficult patterns that the APP might confuse with tumor (potential false positives) include Bronchial epithelium.

### Preliminary Results of Ovary Test Cases

The tumor segmentation is very good. In areas of tumor, the app identifies well over 98% of tumor cells, and the false positive rate is far less than 1%. Ovarian cancers have a variety of architectural patterns, and the app does a good job with all of them.

Difficult patterns that the APP might confuse with tumor (potential false positives) include Follicle cysts, Corpus luteum, Fallopian tube and Blood vessel. Problematic patterns include a very rare pattern of spindled tumor in spindled stroma, and a very rare pattern in which tumor is growing as elongated clefts, in the right half of the upper piece of tissue and along the right edge of the lower piece of tissue; in the left part of the upper piece of tissue, there are some small areas of normal stroma segmented as tumor.

### Preliminary Results of Colon Test Cases

The tumor segmentation is very good. In areas of INVASIVE tumor, the app identifies well over 98% of tumor cells, and the false positive rate is far less than 1%. In areas where the tumor is somewhere between viable and necrotic, the app calls the area background. This may be a good way to deal with these areas, as it prioritizes specificity for viable tumor. The app does an excellent job of segmenting normal mucosa as background. This is no longer an issue. Difficult patterns that the APP might confuse with tumor include Smooth muscle and Blood vessel. In some embodiments, the APP classifies Dysplastic Mucous Epithelium as Tumor. It does not have the necessary context to judge whether the Tumor is Invasive or Non-Invasive.

### Preliminary Results of Breast Test Cases

The tumor segmentation is very good. In areas of tumor, the app identifies well over 98% of tumor cells, and the false positive rate is far less than 1%, except for the architectural patterns noted below in which the app still has over 90-95% sensitivity and specificity. Rare tumor patterns that the APP might only get 90% sensitivity and specificity include Lobular pattern, Small solid growth pattern and Papillary pattern. Difficult patterns that the APP might confuse with tumor (potential false positives) include Germinal centers and Lymphoid aggregates, DCIS and LCIS.

### Preliminary Results of Skin Melanoma Test Cases

The tumor segmentation is outstanding. The app identifies well over 98% of tumor cells, and the false positive rate is far less than 1%, except for the architectural pattern noted below in which the app still has over 90-95% sensitivity and specificity for the overall case. Where the tumor is somewhere between viable and necrotic, the app has a strong tendency to call the area background. This is good way to deal with these areas, since it prioritizes specificity for viable tumor. The app does a very good job of separating inflammation (lymphocytes) from tumor cells. There are very small regions in which groups of cells are incorrectly segmented, for sure. But those regions are very small. Overall this is not a problem at all. Rare tumor patterns where the APP might only get 90% sensitivity and specificity include Spindle pattern. Difficult patterns that the APP might confuse with tumor (potential false positives) include Squamous epithelium, Smooth muscle, Blood vessels and Adnexal structures.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A method for use in a standardized laboratory using a digital image analysis system comprising a computer processor, for a specimen including a staining specific for a marker in the specimen, the method comprising:
scanning an image, having an image magnification, of the specimen; and
detecting, with a computer executing an App, Morphologic, Histopathologic and Pathologic (MHP) features in the image,
wherein the App includes a Neural Network (NN) trained by (a) importing into the NN, control images and associated annotations, wherein each of the associated annotations identifies one of the MHP features, (b) analyzing a test image with the NN to generate testing annotations for portions of the test image, (c) assessing whether the testing annotations are satisfactory, (d) enhancing the NN when the testing annotations made by the NN are unsatisfactory by repeating the importing, the analyzing and the assessing, and (e) creating the App comprising the NN when the testing annotations made by the NN are satisfactory,
wherein the image is neither one of the control images nor the test image, each of the control images is different from the test image, and the control images and the test image comprise images of the MHP features, and
wherein the detecting comprises using magnifications less than or equal to the image magnification to detect one or more of the MHP features.

2. The method of claim 1, wherein the specimen comprises carcinogenic tissue, and the MHP features comprise tumor, background and necrotic.

3. The method of claim 2, wherein the carcinogenic tissue is selected from one or more a lung tissue, an ovary tissue, a colon tissue, a breast tissue, and a skin tissue.

4. The method of claim 1, further comprising visualizing the MHP features using a different color for each of the MHP features.

5. The method of claim 1, further comprising generating a heatmap illustrating concentrations of the MHP features using different colors for each of the MHP features and different intensities of the different colors for respective concentrations of the MHP features.

6. The method of claim 1, further comprising generating a heatmap comprising corings illustrating concentrations of one of the MHP features in a portion of the image.

7. The method of claim 1, wherein the image magnification is equal to or greater than 20×, and the magnifications comprise one or more of 0.5×, 1×, 5×, 10× and 20×.

8. The method of claim 1, further comprising scaling the image to one of the magnifications.

9. The method of claim 1, further comprising quantifying variables for one or more of the MHP features in a portion of the image, wherein the variables comprise one or more of a total tissue area, a percentage of the total tissue area having one of the MHP features, a score indicating a presence of one of the MHP features in the image, a count of nuclei for one of the MHP features, and measurements of a hot zone of one of the MHP features.

10. The method of claim 1, further comprising identifying a hot spot of the MHP features in a portion of the image.

11. The method of claim 1, wherein the specimen is stained using one or more of Hematoxylin and Eosin (H&E), Immunohistochemistry (IHC), Fluorescence In-situ Hybridization (FISH), Chromogenic In-situ Hybridization (CISH), Spectral Imaging, Confocal Microscopy and other simulated staining techniques.

12. An automated method for use in a standardized laboratory using a digital image analysis system comprising a computer processor, for a specimen, the method comprising:
scanning an image, having an image magnification, of the specimen;
detecting, with a computer executing an App, Morphologic, Histopathologic and Pathologic (MHP) features in the image;
quantifying variables for one or more of the MHP features in a portion of the image; and
visualizing the MHP features using different colors for each of the MHP features,
wherein the App includes a Neural Network (NN) trained by (a) importing into the NN, control images and associated annotations, wherein each of the associated annotations identifies one of the MHP features, (b) analyzing a test image with the NN to generate testing annotations for portions of the test image, (c) assessing whether the testing annotations are satisfactory, (d) enhancing the NN when the testing annotations made by the NN are unsatisfactory by repeating the importing, the analyzing and the assessing, and (e) creating the App comprising the NN when the testing annotations made by the NN are satisfactory,
wherein the image is neither one of the control images nor the test image, each of the control images is different from the test image, and the control images and the test image comprise images of the MHP features,
wherein the detecting comprises using magnifications less than or equal to the image magnification to detect one or more of the MHP features,
wherein the image magnification is equal to or greater than 20×, and the magnifications comprise one or more of 0.5×, 1×, 5×, 10× and 20×,
wherein the specimen is selected from one or more a lung tissue, an ovary tissue, a colon tissue, a breast tissue, and a skin tissue,
wherein the MHP features comprise tumor, background and necrotic, and
wherein the specimen comprises a Hematoxylin and Eosin (H&E) staining.

13. The method of claim 12, further comprising generating a heatmap illustrating concentrations of the MHP features using different intensities of the different colors for respective concentrations of the MHP features.

14. The method of claim 12, further comprising generating a heatmap comprising corings illustrating concentrations of one of the MHP features in a portion of the image.

15. The method of claim 12, further comprising annotating each of the MHP features in a portion of the image.

16. The method of claim 12, further comprising scaling the image to one of the magnifications.

17. The method of claim 12, wherein the variables comprise one or more of a total tissue area, a percentage of the total tissue area having one of the MHP features, a score indicating a presence of one of the MHP features in the image, a count of nuclei for one of the MHP features, and measurements of a hot zone of one of the MHP features.

18. The method of claim 12, further comprising identifying a hot spot of the MHP features in a portion of the image.

19. A method for training a Neural Network (NN) to detect Morphologic, Histopathologic and Pathologic (MHP) features from an image of a specimen, the method comprising:
importing into the NN, control images and associated annotations, wherein each of the associated annotations identifies one of the MHP features;
analyzing a test image with the NN to generate testing annotations for portions of the test image;
assessing whether the testing annotations are satisfactory;
enhancing the NN when the testing annotations made by the NN are unsatisfactory by repeating the importing, the analyzing and the assessing; and
creating an App comprising the NN when the testing annotations made by the NN are satisfactory
wherein the image is neither one of the control images nor the test image,
wherein each of the control images is different from the test image, and
wherein one or more of the control images and the test image comprise images of the MHP features.

20. The method of claim 19, further comprising annotating the control images with the respective annotations.
